(19) United States
(12) Patent Application Publication
(10) Pub. No.: US 2004/0088085 A1
(43) Pub. Date: May 6, 2004

(54) Method and system for preventing un-commanded power surge of aircraft engine

(75) Inventor: Antonio Hernani Nobre, Brossard (CA)

Correspondence Address: OGILVY RENAULT (PWC), 1981 MCGILL COLLEGE AVENUE, SUITE 1600, MONTREAL, QC, H3A 2Y3, CA

(73) Assignee: Pratt & Whitney Canada Corp.

(21) Appl. No.: 10/283,079

(22) Filed: Oct. 30, 2002

(51) Int. Cl. B64C 1/00

(52) U.S. Cl. 701/3; 701/14

(57) ABSTRACT

A method of preventing un-commanded power surging of an aircraft engine includes two steps of detecting whether the Weight-On-Wheels signal is on and detecting whether the Low-Power-Lever-Angle-Discrete signal is on, which indicate whether the aircraft is on the ground and whether the throttle lever is positioned for a low power range. If both results are positive, a further step is performed for comparing a measured engine power or thrust level with a predetermined threshold and a final step reduces the fuel supply or shuts down the engine, if the measured engine power level is greater than the predetermined threshold.

### FIELD OF THE INVENTION

The invention relates to aircraft engine control, and in particular to the method and system for preventing aircraft from un-commanded power surging when on the ground.

### BACKGROUND OF THE INVENTION

It is well known that a pilot usually positions the throttle lever in a low power angle range when the aircraft is taxiing on the ground. The aircraft engine or engines should be maintained in a low power output operative condition during the aircraft's taxiing course. Nevertheless, there have been some operational incidents throughout the world in that an engine power surge suddenly occurs when an aircraft is taxiing on the ground, and by the time the pilot acts upon the incident the aircraft has already veered in an un-wanted direction.

There have been well developed technologies for detecting aircraft engine surge and numerous apparatus and methods for aircraft operation monitoring and controlling under normal conditions as well as for detecting abnormal conditions. Nevertheless, the Inventor is not aware of any previous efforts dedicated to addressing the problem of un-commanded power surge of aircraft engines when the aircraft is operated on the ground.

Therefore, there is a need for a method and a system of preventing an un-commanded power surge of an aircraft engine when the aircraft is operated on the ground.

### SUMMARY OF THE INVENTION

One object of the present invention is to provide a method of preventing aircraft from un-commanded power surging when on the ground.

Another object of the present invention is to provide a system for preventing aircraft from un-commanded power surging when on the ground.

The present invention according to one aspect thereof is directed to a method of preventing an aircraft from un-commanded power surging when on the ground. The method comprises: a)automatically detecting whether the aircraft is on the ground; b)automatically detecting whether a power setting of an engine of the aircraft is below a predetermined level; c)automatically detecting whether a power output of the engine is greater than a predetermined threshold; and d)automatically acting on an engine's fuel control to prevent a power surge when the results from steps (a), (b) and (c) are positive

In an embodiment of the present invention, a method of preventing an aircraft from un-commanded power surging when on the ground, comprises a) detecting whether a Weight-On-Wheels signal is on; b) detecting whether a Low-Power-Lever-Angle-Discrete signal is received; c) detecting whether a power level of an engine of the aircraft is greater than a predetermined threshold; and d)acting on engine fuel control to prevent a power surge when the results from the steps a), b), and c) are positive.

The present invention according to another aspect thereof is directed to a system for preventing an aircraft from un-commanded power surging when on the ground. The system comprises: means for detecting whether the aircraft is on the ground; means for detecting whether a power setting of an engine of the aircraft is below a predetermined level; means for measuring power/thrust levels of the engine; fuel metering control means for controlling fuel supply to the engine; and a ground traction protection processing device for the data processing, adapted to send an action signal to actuate the fuel metering control means for a controlling action on the fuel supply

In the embodiment of the present invention, a system for preventing an aircraft from un-commanded power surging when on the ground, generally comprises a WOW (Weight-On-Wheels) sensor, a TLP (Throttle Lever Position) switch, a P/TL (Power/Thrust Level) sensor, a fuel metering control means and a ground traction protection processing device. The WOW sensor is installed in the aircraft for generating a Weight-On-Wheels signal when the aircraft is on the ground. The TLP switch is installed in the aircraft for generating a Low-Power-Lever-Angle-Discrete signal when a throttle lever position is in a low engine power range. The P/TL sensor is installed in the aircraft engine and is adapted for measuring power levels of the engine and generating a signal corresponding to the power level. The fuel metering control means is installed in the engine for controlling the fuel supply to the engine. The ground traction protection processing device for data processing is adapted to compare the signal received from the P/TL sensor to a predetermined engine power threshold stored therein when having received the Weight-On-Wheels signal and the Low-Power-Lever-Angle-Discrete signal, and then to send an action signal to the fuel metering control means in order to have a controlling action on the fuel supply.

The system preferably uses the existing hardware of the aircraft and the engine. The computer of the engine controller is augmented with ground traction protection software so as to perform the ground traction protection processing device's function defined in the system. The ground traction protection processing device is particularly designed to perform an algorithm in accordance with the method of preventing aircraft from un-commanded power surging when on the ground, as defined in the present invention. Therefore, the present invention provides a very simple and convenient method of enabling an aircraft to be safely guided in order to prevent any sudden un-commanded power surge when the aircraft is taxiing or otherwise operated with low power commanded engines on the ground. The system according to the present invention can be simply and conveniently built at a low cost during the manufacturing of new aircraft, or in the retrofitting of existing aircraft, because there is generally no additional hardware needed.

Other advantages and features of the present invention will be better understood with reference to a preferred embodiment of the present invention described hereinafter.

### BRIEF DESCRIPTION OF THE DRAWINGS

Having thus generally described the nature of the present invention, reference will now be made to the accompanying drawings, showing by way of illustration the preferred embodiment thereof, in which:

FIG. 1 is a diagram schematically illustrating a ground traction protection system according to one embodiment of the present invention; and

FIG. 2 a diagram illustrating a data processing procedure executed by the ground traction protection processing device of the system shown in FIG. 1.

### DETAILED DESCRIPTION OF THE PREFERRED EMBODIMENT

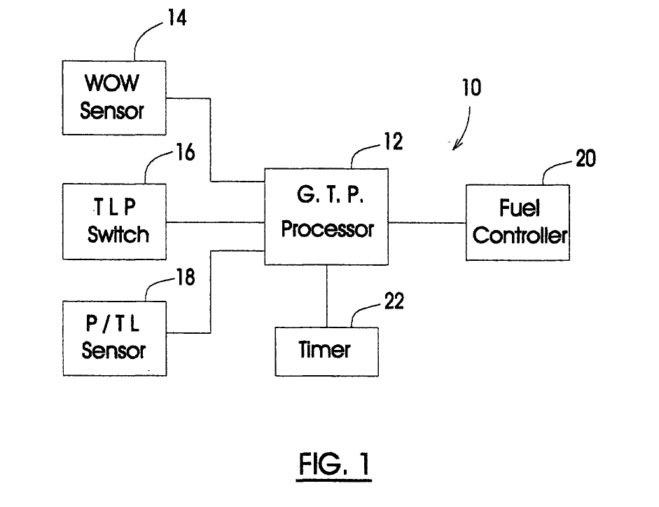

Referring to FIG. 1, a preferred embodiment of a “ground traction protection system” as the present invention is sometimes referred to in this application, generally indicated by numeral 10 is installed in an engine of an aircraft (not shown) for preventing an un-commanded power surge of an aircraft engine when the aircraft is on the ground, particularly when taxiing. The ground traction protection system 10 according to one embodiment of the present invention generally uses various hardware which has already existed on the aircraft for other purposes. A specifically designed ground traction protection software is installed in the computer of the engine controller so as to perform the function of a ground traction protection processing device 12 in the system 10. The ground traction protection processing device 12 receives three inputs, two from the aircraft and one from the engine, for data processing.

The first input is from a sensor indicating that the aircraft is on the ground. The preferred embodiment employs a Weight-On-Wheels (WOW) sensor 14 which is installed on the wheel assembly of the aircraft. The WOW sensor 14 senses the weight of the aircraft loaded on the wheels when the aircraft is on the ground, and generates a corresponding Weight-On-Wheels signal which is sent to the ground traction protection processing device 12 for data processing. After the aircraft takes off and flies in the air the aircraft weight is no longer loaded on the wheels and the WOW sensor 14 stops generating the Weight-On-Wheels signal. Therefore, the ground traction protection processing device 12 is able to determine whether the aircraft is currently on the ground or not, depending on whether the Weight-On-Wheels signal from the WOW sensor 14 is detected or not.

The second input is from a sensor indicating information which permits a determination of whether the engine power setting is below a pre-determined level. The preferred embodiment employs a Throttle Lever Position (TLP) switch 16 which is usually installed in the aircraft control system, associated with the throttle lever. The throttle lever can be manipulated by the pilot in different angular positions to control the throttle which changes the fuel flow rate to the combustor of the aircraft engine, such that the thrust provided from the engine to the aircraft can be manipulated by the pilot. When the throttle lever is positioned within an angle range corresponding to the throttle being partially open for low engine power, for example less than 50% of the full power output of the engine, the TLP switch 16 is activated to generate a Low-Power-Lever-Angle-Discrete signal which is sent to the aircraft controller to alert the pilot of such a situation. In this embodiment of the present invention, the TLP switch 16 is used to generate the second input from the aircraft to the ground traction protection processing device 12 in order to ensure that the engine is left in a low power commanded condition. Such low power commanded condition is required most of the time while the aircraft is on the ground, particularly when taxiing or on standby. In the taking-off condition, as a contrast, the aircraft needs the maximum thrust provided by the aircraft engine and the throttle lever must be positioned in an angle for full engine power output, and the TLP switch 16 will not be activated to generate the Low-Power-Lever-Angle-Discrete signal.

The third input is from a sensor for sensing the Power/Thrust Level of the engine(s). The preferred embodiment employs a Power/Thrust Level sensor. A Power/Thrust Level sensor 18 which will be referred to as a P/TL sensor 18 hereinafter, is installed on the aircraft engine for measuring the power or the thrust output of the engine. The P/TL sensor 18 in this embodiment, is used to generate the third input from the aircraft engine to the ground traction protection processing device 12. The type of P/TL sensor 18 can vary depending on the type of engine. For example, means for measuring torque can be used for turboprops, while means for measuring fan speed or means for measuring engine fan pressure rise can be used for turbofan jet engines. The P/TL sensor 18 measures the engine Power/Thrust Level and generates a P/TL signal 18 corresponding to the measured varying power/thrust level of the engine. This varying P/TL signal 18 is sent to the ground traction protection processing device 12 to be processed for comparison to a predetermined threshold which is stored in a memory unit of the ground traction protection processing device 12. The predetermined threshold is equivalent to, for example 50% of the full power output of the aircraft engine, and can be parameters of the engine output torque, fan speed or engine fan pressure rise, etc., corresponding to the type of P/TL sensor 18.

Depending on the result of data processing of the three inputs, the ground traction protection processing device 12 generates an action signal to modify the engine power output. In the preferred embodiment, the system 10 generates an action signal and sends that action signal to a fuel metering control means 20 of the aircraft engine to have a controlling action on the fuel supply in order to reduce the fuel supply to the engine combustor, or completely shut down the engine. The fuel metering control means 20 is a fuel controlling device and the imbedded device to reduce fuel is completely independent from the normally manipulated throttle lever.

The system 10 may further include a timer 22 which is used to set a time period for activating the system such that the system 10 will be disarmed when the time period set on the timer 22 expires. The system 10 is generally used for ground traction protection of the aircraft and therefore is not necessarily always armed. With the timer 22, which can be conveniently designed within the software for the ground traction protection processing device 12, it is convenient to arm the system 10 only when it is needed.

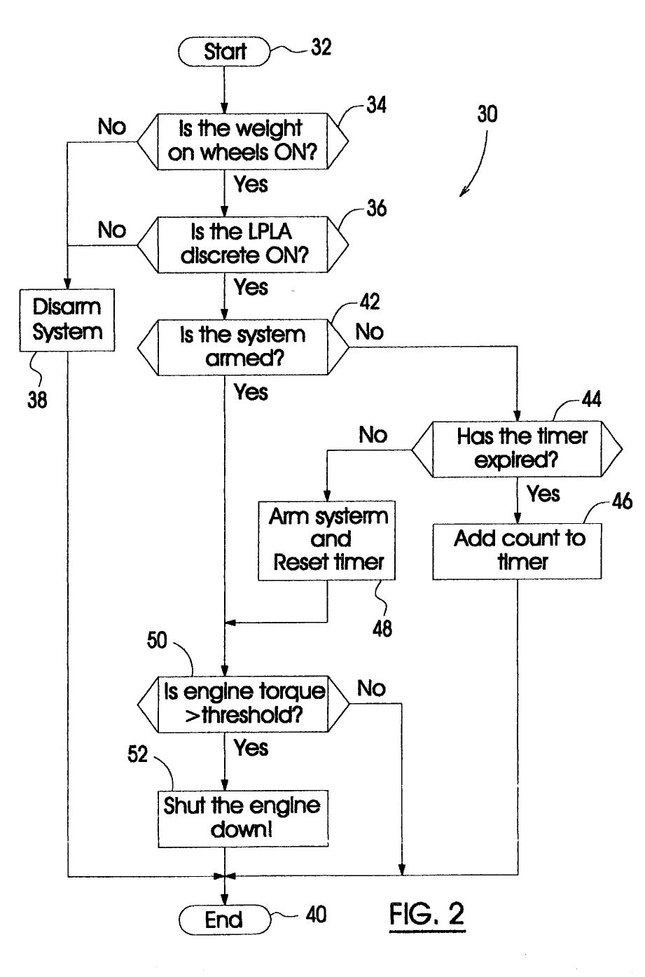

A diagram 30 shown in FIG. 2 illustrates a general data processing procedure executed by the software designed for the ground traction protection processing device 12 of a preferred embodiment of the system 10. The processing procedure illustrated by the diagram 30 can be manually or automatically started as indicated in step 32. Upon start, the ground traction protection processing device 12 in steps 34 and 36 detects whether the Weight-On-Wheels signal is on and received, and detects whether the Low-Power-Lever-Angle-Discrete signal is on and received. If the Weight-On-Wheels signal is not received, which identifies a not-on-ground condition of the aircraft, the ground traction protection is not needed and the ground traction protection processing device 12 disarms the system 10 immediately, as shown in step 38. No further steps are performed and the procedure is ended as indicated in step 40.

Similarly, if the Low-Power-Lever-Angle-Discrete signal is not received, which indicates that the aircraft is in a high engine power operation status, ground traction protection is not needed and the ground traction protection processing device 12 disarms the system 10 immediately, as shown in step 38, and the procedure is ended in step 40. The aircraft with a high engine power status can be taking off of the runway when the Weight-On-Wheels signal is on, or is in a flight condition when the Weight-On-Wheels signal is off. The aircraft in either condition does not need the ground traction protection.

When the described ground traction protection processing device 12 detects that both the Weight-On-Wheels signal and the Low-Power-Lever-Angle-Discrete signal are on, which identifies that the aircraft is on the ground with a low engine power status, the aircraft is either in its taxiing course or is stopped on the ground with the engine running on standby. In either condition ground traction protection is desirable and the ground traction protection processing device 12 in step 42 further checks whether the system 10 is armed. If the result is negative, the ground traction protection processing device 12 in step 44 determines whether the time period set on the timer 22 has expired or not. If the time period set on the timer 22 has expired, the timer 22 is set for a new time period predetermined for a next operation of the system 10, as indicated in step 46 and the current procedure is ended as in step 40. This could happen for example, when the aircraft is decelerating the engines from high power, and conditions of steps 34 and 36 are satisfied. Nevertheless, if the time period set on the timer 22 has expired and the conditions of steps 34 and 35 are satisfied, the ground traction protection processing device 12 must arm the system 10 immediately, and reset the timer 22 for the next operation of the system 10, as shown in step 48, so that the ground traction protection processing device 12 is enabled to further detect whether a power/thrust level of the engine of the aircraft is greater than the predetermined threshold stored therein, as shown in step 50. The predetermined threshold generally corresponds to the allowed maximum power output of the engine when the throttle lever is positioned within the low power angle range, such as for example 50% of the full power/thrust level of the engine in this embodiment. In a normal condition, when the throttle lever is positioned within the low power angle range and the Low-Power-Lever-Angle-Discrete signal is on, the engine power/thrust level should be smaller than the predetermined threshold and the ground traction protection processing device 12 will end the procedure.

However, in an abnormal situation, when the throttle lever is positioned within the low power angle range and the Low-Power-Lever-Angle-Discrete signal is on, an un-commanded power surge may occur so that the engine power/thrust level measured by the P/TL sensor 18 is greater than the predetermined threshold and the result of the checking in step 50 is positive. Upon the positive result, the ground traction protection processing device 12 generates an action signal and sends that signal to the fuel metering control means 20 to either reduce the fuel supply to the engine or completely shut down the engine, as shown in step 52.

It should be noted that the hardware of the ground traction protection system 10 may not exist in some types of aircraft engines. Therefore, the hardware which is necessary in the ground traction protection system 10 should be specially installed such that the ground traction protection system 10 is enabled to perform the complete procedure in accordance with the present invention.

The above-described embodiment is an example of the present invention. The WOW sensor TLP switch and P/TL sensor may be replaced by other detecting means which are adapted to detect the aircraft on-ground status, power setting of the engine and power/thrust output levels, respectively. For example, besides WOW sensors, many other means of providing the first input (Aircraft On Ground) may be provided, such as, for example, a zero airspeed indicator, radar altimeter, a global positioning system, etc. may be used. For providing the second and third inputs, many various mechanical, electrical and electronic means within the engine and associated systems are available to determine the engine power and Power/Thrust settings. Similarly, one may choose alternate means of affecting the engine output settings. Still other means for providing the input and outputs to the present invention will be apparent to those skilled in the art, and thus need not be exhaustively listed here.

Therefore, changes and modifications to the embodiments of the present invention described above may be made without departing from the spirit and the scope of the present invention which are intended to be limited only by the scope of the appended claims.

I/we claim:

1. A method of preventing an aircraft from un-commanded power surging when on the ground, comprising:
a) detecting whether a Weight-On-Wheels signal is on;
b) detecting whether a Low-Power-Lever-Angle-Discrete signal is on;
c) detecting whether a power level of an engine of the aircraft is greater than a predetermined threshold; and
d) acting on engine fuel control to prevent a power surge when the results from the steps a), b) and c) are positive.

2. A method as claimed in claim 1 wherein the step (d) comprises shutting down of the engine

3. A method as claimed in claim 1 further comprising setting a timer to activate an operation of steps a) to d).

4. A method as claimed in claim 1 further comprising a step of terminating an operation of the remaining steps when the result from either step a) or step b) is negative.

5. A method as claimed in claim 1 wherein the predetermined threshold of the power level of the engine is less than 50% of a full power level of the engine.

6. A system for preventing an aircraft from un-commanded power surging when on the ground, comprising:
a WOW (Weight-On-Wheels) sensor installed in the aircraft for generating a Weight-On-Wheels signal when the aircraft is on the ground;
a TLP (Throttle Lever Position) switch installed in the aircraft for generating a Low-Power-Lever-Angle-Discrete signal when a throttle lever position is in a low engine power range;
a P/TL (Power/Thrust Level) sensor installed in the engine adapted for measuring power/thrust levels of the engine and thereby generating a signal corresponding to the measured power/thrust level;
a fuel metering control means for controlling fuel supply to the engine; and
a ground traction protection processing device for data processing, adapted to compare the signal received from the P/TL sensor to a predetermined engine power threshold stored therein when having received the Weight-On-Wheels signal and the Low-Power-Lever-Angle-Discrete signal, and then to send an action signal to the fuel metering control means to have a controlling action on the fuel supply.

7. A system as claimed in claim 6 wherein the system is enabled to be manually turned on.

8. A system as claimed in claim 6 wherein the system is enabled to be automatically turned on.

9. A system as claimed in claim 6 wherein the system is enabled to be disarmed when one of the WOW sensor and the TLP switch does not generate the corresponding signal.

10. A system as claimed in claim 6 wherein the system comprises a timer such that the system can be armed only during a time period set on the timer.

11. A method of preventing an aircraft from un-commanded power surging when on the ground, comprising:
a) automatically detecting whether the aircraft is on the ground;
b) automatically detecting whether a power setting of an engine of the aircraft is below a predetermined level;
c) automatically detecting whether a power output of the engine is greater than a predetermined threshold; and
d) automatically acting on an engine's fuel control to prevent a power surge when the results from steps (a), (b) and (c) are positive.

12. A method as claimed in claim 11 wherein the step (a) is performed by detecting whether a Weight-On-Wheels signal is on.

13. A method as claimed in claim 11 wherein the step (b) is performed by detecting whether a Low-Power-Angle-Discrete signal is on.

14. A system for preventing an aircraft from un-commanded power surging when on the ground, comprising:
means for detecting whether the aircraft is on the ground;
means for detecting whether a power setting of an engine of the aircraft is below a predetermined level;
means for measuring power/thrust levels of the engine;
fuel metering control means for controlling fuel supply to the engine; and
a ground traction protection processing device for the data processing, adapted to send an action signal to actuate the fuel metering control means for a controlling action on the fuel supply.

15. A system as claimed in claim 14 wherein the means for detecting whether the aircraft is on the ground comprises a WOW (Weight-On-Wheels) sensor installed in the aircraft for generating a Weight-On-Wheels signal when the aircraft is on the ground.

16. A system as claimed,in claim 14 wherein the means for detecting whether a power setting of the engine comprises a TLP (Throttle-Lever-Power) switch installed in the aircraft for generating a Low-Power-Angle-Discrete signal when a throttle lever position is in a low engine power range.

17. A system as claimed in claim 14 wherein the means for measuring power/thrust levels of the engine comprises a P/TL (Power/Thrust Level) sensor installed in the engine for measuring the power/thrust levels of the engine and thereby generating a signal corresponding to the measured power/thrust level.
